(19) United States
(12) Patent Application Publication
(10) Pub. No.: US 2004/0151621 A1
(43) Pub. Date: Aug. 5, 2004

(54) Incubator

(75) Inventors: Yoshihiro Seto, Minami-ashigara-shi (JP); Tomoyuki Takiue, Minami-ashigara-shi (JP); Nobuaki Tokiwa, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/763,211

(22) Filed: Jan. 26, 2004

(30) Foreign Application Priority Data
Jan. 24, 2003 (JP) 016384/2003

(51) Int. Cl. G01N 1/00

(52) U.S. Cl. 422/50

(57) ABSTRACT

An incubator is provided which is capable of quickly heating a dry analysis element to a predetermined temperature by efficient heat supply. An incubator for accommodating and holding at a predetermined constant temperature a dry analysis element spotted with a sample includes: upper and lower blocks, one of which is movable towards and away from the other, for sandwiching therebetween the dry analysis element from above; and a heater provided in one of the blocks. The block provided with the heater and the other block are brought into contact with each other to preheat the other block before introducing the dry analysis element therebetween. The introduced dry analysis element is then sandwiched between the blocks and quickly heated from above and below by both blocks.

### BACKGROUND OF THE INVENTION

1. Field of the Invention

The present invention relates to an incubator, which is used in a biochemical analysis apparatus for spotting a dry analysis element with a sample such as blood or urine and detecting the concentration, ion activity and the like of a specific biochemical component contained in the sample, and operates to hold the spotted dry analysis element at a predetermined constant temperature,

2. Description of the Related Art

Conventionally, there have been developed and practically implemented calorimetric dry analysis elements with which the content of a specific biochemical component or specific solid component contained in a sample can be quantitatively analyzed by merely spotting a droplet of the sample thereon, and electrolytic dry analysis elements with which the activity of a specific ion contained in a sample can be determined by merely spotting a droplet of the sample thereon. Biochemical analysis apparatuses using such dry analysis elements are favorably used in medical institutions, laboratories and the like owing to their capability of analyzing samples easily and quickly. The colorimetry method using calorimetric dry analysis elements is as follows: a droplet of a sample is spotted on a dry analysis element; the analysis element having the sample thereon is held at a constant temperature for a predetermined time in an incubator so that a coloring reaction (pigment forming reaction) occurs; the optical density of the color formed by the coloring reaction is optically measured by exposing the analysis element to measuring light containing a wavelength which is pre-selected according to the combination of the component to be analyzed and the reagent contained in the analysis element; the optical density of the analysis element is measured; and the concentration of the component to be analyzed is determined on the basis of the optical density according to a calibration curve representing the relationship between the concentration of the specific biochemical component and the optical density. On the other hand, in the potentiometry method using an electrolytic dry analysis element, the activity of a specific ion contained in a sample spotted on an ion selective electrode pair of a dry analysis element is potentiometrically measured through the use of a reference solution, instead of measuring the optical density.

In either of colorimetry or potentiometry, it is indispensable that the dry analysis element spotted with the sample is held at a constant temperature (incubate) for a predetermined time in order to ensure the accuracy of measurement. For this purpose, an incubator is used, for example, to incubate a colorimetric dry analysis element at 37±0.2° C. and an electrolytic dry analysis element at 30±1° C.

Various methods of heating dry analysis element by an incubator as mentioned above are well known in the art. For example, U.S. Pat. No. 4,298,571 discloses enclosure of a dry analysis element and the part of an incubator in contact with the dry analysis element in a chamber kept at a constant temperature, and heating the entire system including the dry analysis element and the part of the incubator in contact with the dry analysis element. Alternatively, U.S. Pat. No. 5,660,793 discloses an incubator with an upper base portion having a plurality of sliding holes which extend vertically and accommodate pressing members. A heater is placed in the upper base portion to heat the dry analysis element by way of the pressing members which are heated by heat supplied thereto through the inner surface of the sliding holes.

After being heated to a predetermined temperature, the dry analysis element inserted in the incubator is subjected to a measurement after a predetermined time period or subjected to measurements at predetermined time intervals. When the temperature of the dry analysis element before being introduced into the incubator is low because of cold weather or other reasons and thus a long time is required until the predetermined temperature is reached, there arises a problem that the measurement accuracy is affected.

With the heating method described in U.S. Pat. No. 4,298,571, the incubator is sealed during heating, and therefore when a cold dry analysis element is placed in the element chamber, the temperature rising rate of the dry analysis element is low even if an element chamber has been controlled at a predetermined temperature, because the element is heated by way of air, and thus it takes a long time until the predetermined temperature is reached. On the other hand, with the heating method described in U.S. Pat. No. 5,660,793, a pressing member contacts the dry analysis element, and therefore this contact portion of the dry analysis element has good heat transfer efficiency. However, since the dry analysis element is heated only from above, the temperature rising rate of the dry analysis element is not still sufficient, and it also takes a long time until a predetermined temperature is reached.

### SUMMARY OF THE INVENTION

In view of the foregoing, an object of the invention is to provide an incubator which is capable of efficiently supplying heat to a dry analysis element and quickly heating the element to a predetermined temperature even under severe conditions such as in cold weather.

In accordance with the present invention, there is provided an incubator for accommodating and holding a dry analysis element spotted with a sample at a predetermined constant temperature, comprising:

first and second blocks, at least one of which is movable towards and away from the other, for sandwiching therebetween the dry analysis element; and

a heater provided in at least one of the blocks, wherein:

the first and second blocks are brought into contact with each other to preheat the blocks prior to accommodating the dry analysis element.

Specifically, the heater is provided in the first block, which is a lower block for temperature-controlling the first block; the lower block and the second block, which is an upper block, are brought into contact with each other; the upper block is preheated by heat transmission; the electrolytic dry analysis element is introduced and sandwiched between the lower block and the upper block; and the dry analysis element is heated by the heat of both blocks.

Preferably, the dry analysis element is of the electrolytic type for measuring the ion activity of a sample. In this case, it is preferable that potential measuring probes are provided at either one of the upper and lower blocks which is movable towards and away from the other of the blocks.

Preferably, the incubator further comprises a cover which is made of a metal material and covers the upper block, the cover having a heat insulator placed at a part that contacts with the upper block. In this case, the heat insulator of the cover is preferably provided with a recess.

Preferably, the preheating time is changed according to the environmental temperature. When the environmental temperature is low, the preheating time is set long.

According to the present invention as described above, in the case that an environmental temperature is high, a block not having a heater is preheated by a block having a heater before introducing therebetween a dry analysis element. Owing to such a simple single heater structure, the dry analysis element can be efficiently heated by both blocks contacting the element while it is accommodated between the blocks. Even if a cold dry analysis element is introduced on a cold day or the like, the analysis element can be heated to a predetermined temperature in a short time, by utilizing heaters of both blocks as necessary, which results in higher measurement accuracy and good cost efficiency. Particularly, a difference in temperature rise time between elements due to the environmental temperature variation can be reduced, and consequently the measuring efficiency can be improved.

When the present invention is applied to an incubator for processing electrolytic dry analysis elements, the lower block and the upper block can be relatively moved towards and away from each other by employing a mechanism for abutting the potential measuring probes against the dry analysis element, which is advantageous in terms of the utility of the mechanism.

When a cover for covering the upper block is provided with a heat insulator, the preheat efficiency can be increased by reducing the amount of heat dissipated into the cover, the time for preheating the upper block can be reduced by quickly preheating this block, and the accuracy of holding the dry analysis element at a predetermined temperature can be ensured. Further, the accuracy of measuring the quantity of weak electricity can be enhanced by the shielding effect of the cover made of metal. When the heat insulator is provided with a recess, the area of contact with the upper cover decreases and the insulation effectiveness is further enhanced, such that the preheat efficiency can be improved.

When the preheat time is changed according to the environmental temperature, the temperature accuracy of the dry analysis element is increased such that the measuring accuracy can be increased.

### BRIEF DESCRIPTION OF THE DRAWINGS

FIG. 1 is a front view, partially in cross section, showing a schematic construction of a biochemical analysis apparatus having an incubator according to one embodiment of the present invention;

FIG. 2 is a plan view showing the mechanism of an essential part of the biochemical analysis apparatus in FIG.

FIG. 3 is a perspective view showing an incubator section according to an embodiment of the present invention;

FIG. 4 is a perspective view similar to FIG. 3 except that a cover is removed;

FIG. 5 is a perspective view similar to FIG. 4 except that a lower block is lowered;

FIGS. 6A to 6C are schematic front views respectively showing different operating states of the incubator;

FIG. 7 is a cross sectional view showing an example of the construction of the essential part of the cover; and

FIG. 8 is a cross sectional view showing another example of the construction of the essential part of the cover.

### DESCRIPTION OF THE PREFERRED EMODIMENTS

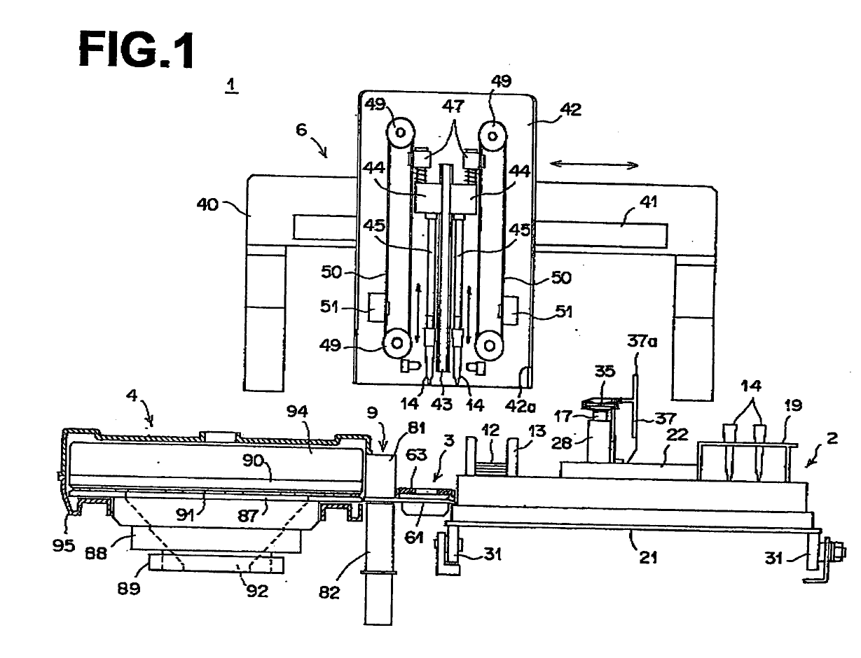

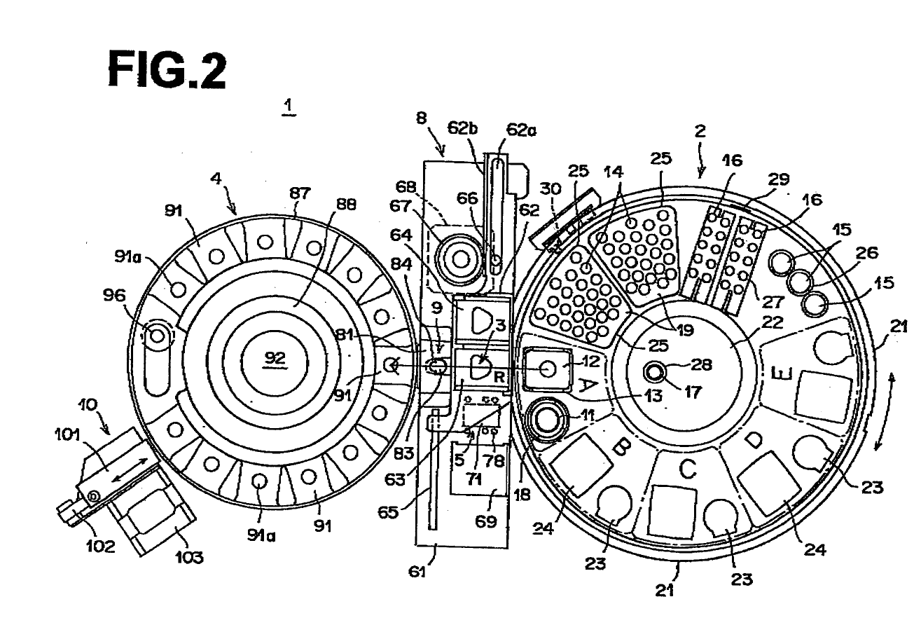

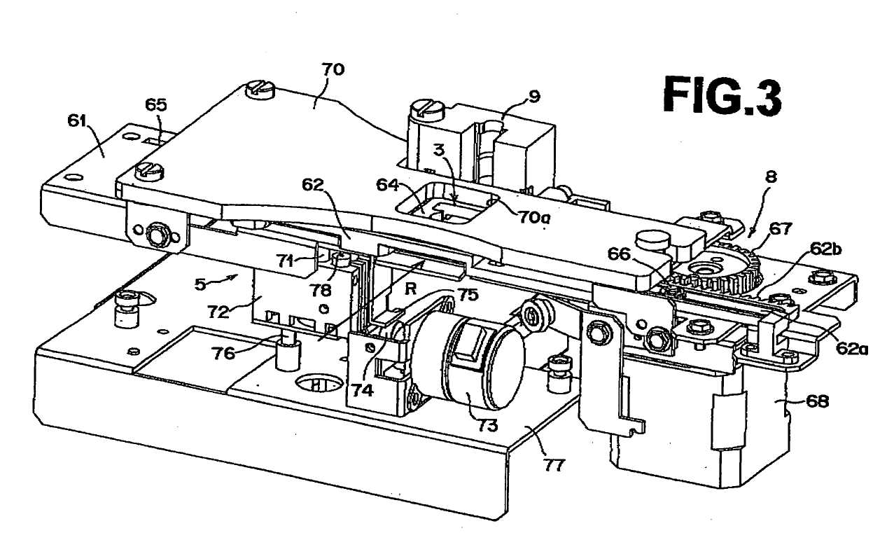

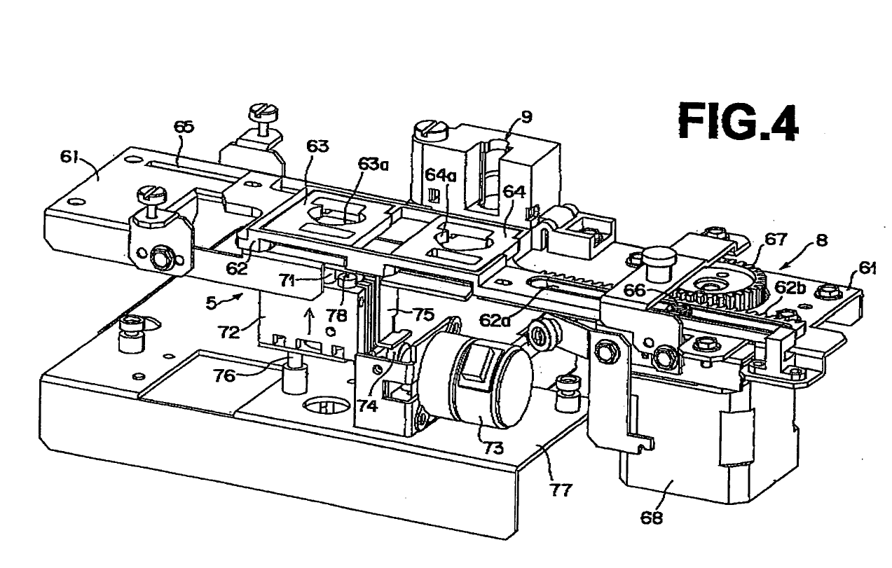

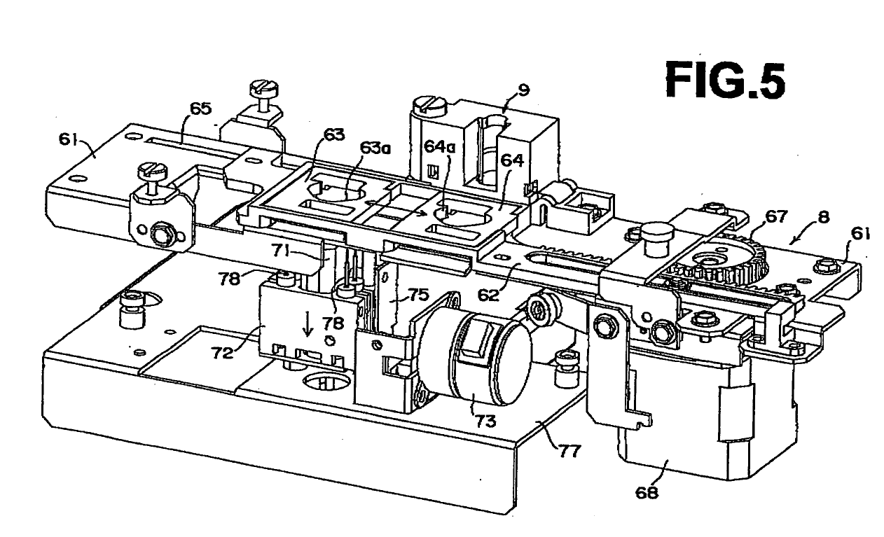

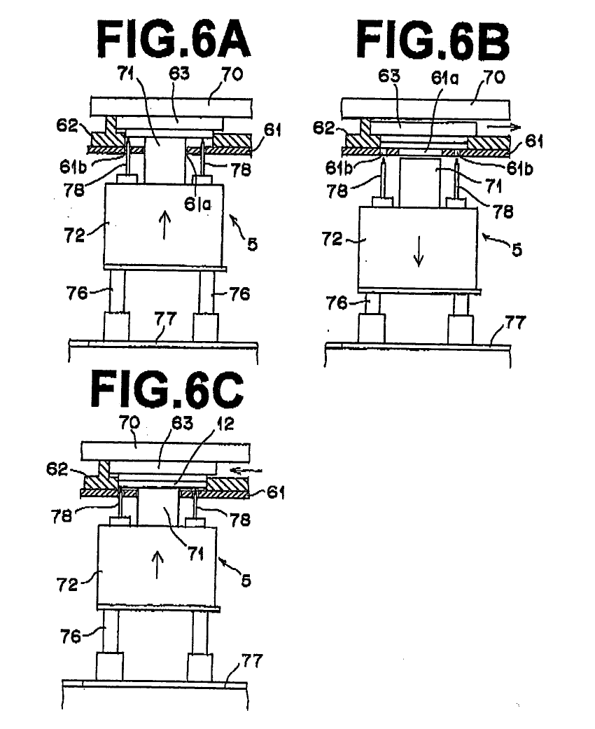

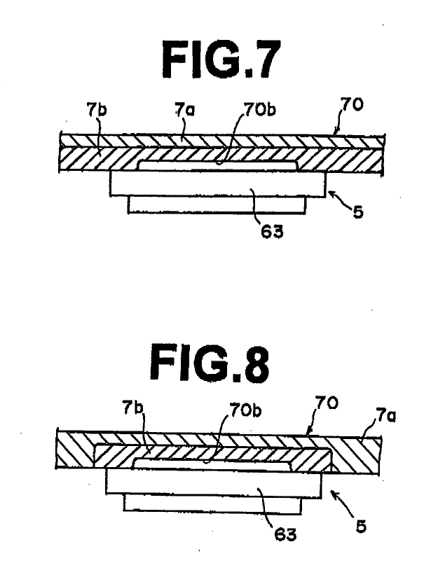

Hereinafter, preferred embodiments of the present invention will be described with reference to the drawings. FIG. 1 is a front view, partially in cross section, showing a schematic construction of a biochemical analysis apparatus according to one embodiment of the present invention. FIG. 2 is a plan view showing the essential part of the biochemical analysis apparatus shown in FIG. 1. FIG. 3 is a perspective view showing an incubator section according to an embodiment ! of the present invention, FIG. 4 is a perspective view similar to FIG. 3 except that a cover is removed, FIG. 5 is a perspective view similar to FIG. 4 except that a lower block is lowered, and FIGS. 6A to 6C are front views, partially in cross section, of the incubator respectively showing different operating states of the incubator. FIGS. 7 and 8 are cross sectional views showing examples of the construction of the essential part of the cover.

First, a description of a general configuration of a biochemical analysis apparatus 1 will be given in connection with FIGS. 1 and 2. This biochemical analysis apparatus 1 comprises a sample tray 2, a spotting station 3, a first incubator 4 for colorimetry measurement, a second incubator 5 for potentiometry measurement (see FIG. 2), a spotting unit 6, an element transfer mechanism (not shown), a transport mechanism 8, a tip disposal area 9, and an element discarding mechanism 10, etc.

The sample tray 2 is circular in shape, and provided with a sample container 11 holding therein a sample, an element cartridge 13 holding therein unused dry analysis elements 12 (e.g., colorimetric dry analysis elements and electrolytic dry analysis elements), and consumables (e.g., nozzle tips 14, dilution containers 15, mixing cups 16, and reference solution containers 17). The sample container 11 is set in the sample tray via a sample adaptor 18, and a number of nozzle tips 14 are also set in the sample tray in a state in which the nozzle tips-are held in a tip rack 19.

The spotting station 3 for spotting the delivered dry analysis element 12 with a sample such as plasma, whole blood, serum, urine or the like is disposed on an extended line from the centerline of the sample tray 2, At the spotting station 3, in the case of a colorimetric dry analysis element 12, a sample is spotted thereon by the spotting unit 6, while in the case of an electrolytic dry analysis element 12, a sample and reference solution are spotted thereon by the spotting unit 6. The tip disposal area 9 into which the nozzle tips 14 are discarded is disposed following and adjacent to the spotting station 3.

The first incubator 4 is circular in shape and disposed on the aforementioned extended line on a side of the tip disposal area 9 opposite the sample tray 2. The first incubator 4 holds therein a colorimetric dry analysis element 12, wherein the analysis element is held at a constant temperature for a predetermined time and then subjected to colorimetry measurement.

The second incubator 5 (described later in detail with reference to FIGS. 3 to 8) is disposed adjacent to and alongside the spotting station 3, and holds therein an electrolytic dry analysis element 12, where the analysis element is incubated for a predetermined time and subjected to potentiometry measurement.

The element transfer mechanism (not shown) has an element transfer member (transfer bar) positioned within the sample tray 2. The element transfer member transfers a dry analysis element 12 from the sample tray 2 to the spotting station 3 and in turn to the first incubator 4 along a linear element transfer path R (see FIG. 2) which extends between the center of the sample tray 2 and the center of the first incubator 4 through the spotting station 3 and the tip disposal area 9. The transport mechanism 8, which also serves as the spotting station 3, is provided for transferring an electrolytic dry analysis element 12 from the spotting station 3 to the second incubator 5 in the direction perpendicular to the element transfer path R The spotting unit 6 is provided at the upper part of the analysis apparatus and includes a spotting nozzle 45 adapted to move vertically. The spotting nozzle 45 is also capable of traveling along the same straight line as the aforementioned element transfer path R, and operates to spot the analysis element with the sample and reference solution, dilute the sample with the diluent, and mix the diluted sample. The spotting nozzle 45 has a nozzle tip 14 attached to the tip end thereof, and serves to suction/discharge the reference solution and the like with respect to the inside of the nozzle tip 14. The spotting nozzle 45 is provided with syringe means (not shown) which suctions and discharges such reference solution and the like. The used nozzle tip 14 is removed and dropped for disposal at the tip disposal area 9.

The first incubator 4 is provided with the element discarding mechanism 10 (see FIG. 2) which pushes the colorimetric dry analysis element 12 after measurement towards the central portion of the first incubator 4 and drops the element for disposal. The used element may be discarded by the aforementioned element transfer mechanism 7. Meanwhile, the electrolytic dry analysis element 12 after being subjected to the measurement in the second incubator 5 is discarded into a discarding hole 69 by the transport mechanism 8.

A blood filtering unit (not shown) for separating blood plasma from blood is provided beside the sample tray 2.

In the following the construction of each section of the apparatus will be specifically described. The sample tray 2 comprises a rotary disk 21 which is rotated in opposite directions, and a disk-shaped non-rotatable part 22 disposed at the center part thereof.

As shown in FIG. 2, the rotary disk 21 includes: five sample mounting sections 23 (A-E) for holding via the sample adapter 18 a sample container 11 (e.g., blood-collecting tube) containing therein a sample; five element mounting sections 24, which are respectively positioned adjacent the sample mounting sections, for holding the element cartridge 13 that accommodates in a stacked form the unused dry analysis elements 12 usually including various types as required corresponding to a measuring item of each sample measurement; two tip mounting sections 2S for holding the tip rack 19 that includes nozzle tip holding holes for respectively receiving a number of nozzle tips 14; three diluent mounting section 26 for holding the diluent container 15 containing therein diluent, a cup mounting section 27 for holding a mixing cup 16 (a molded product provided with a plurality of cup-like recesses) used for mixing therein the diluent and sample, These sections are arranged along an arc.

The non-rotatable part 22 includes a reference solution mounting section 28 of hollow-cylindrical shape for holding therein the reference solution container 17 containing the reference solution. The reference mounting section 28 is located on the line extended from the element transfer path R within the range of the movement of the spotting nozzle 45 and provided with an anti-evaporation cap 35 (see FIG. 1) for to opening and closing the opening of the reference solution container 17.

The anti-evaporation cap 35 is held and urged in the closing direction by a pivotable member 37, and the lower end of the pivotable member 37 is pivotally supported by the non-rotatable part 22. An upper end engagement portion 37a of the pivotable member 37 can be brought into contact with a bottom end corner 42a of a movable frame 42 of the spotting unit 6. The movable frame 42 approaches the pivotable member 37 for auctioning the reference solution such that the pivotable member is allowed to pivot towards its opening direction. Accordingly, the anti-evaporation cap 35 opens the reference solution container 17 and the spotting nozzle 45 is allowed to suction the reference solution. In other states, the anti-evaporation cap 35 closes the opening of the reference solution container 17 to prevent evaporation of the reference solution, which inhibits degradation of the measurement accuracy due to the change in concentration of the reference solution.

The rotary disk 21 is supported at its perimeter by a support roller 31 and rotatably held at the central portion thereof by a supporting shaft (not shown). A timing belt is wound around the outer circumference of the rotary disk 21 and rotates the rotary disk 21 in opposite directions with the aid of a driving motor. The non-rotatable part 22 is non-rotatably mounted to the supporting shaft mentioned above.

A plurality of various unused dry analysis elements 12, which are usually arranged in a stacked form in a mixed state, are inserted in the cartridge 13 from above. When the cartridge is mounted to the element mounting section 24, the lower most dry analysis element 12 is positioned at the same level as that of an element transfer surface. The front wall of the element cartridge has at the lower most part a port which allows only a single analysis element to pass through, while the rear wall thereof has an opening in which the element transfer member can penetrate. In the bottom wall of the element cartridge 13, a window is formed such that a lot number etc. represented by bar codes, dots or the like provided on the bottom surface of the dry analysis element 12 can be read from below of the cartridge.

On the other hand, the sample adapter 18 is formed in a tubular shape, and the sample container 11 is inserted therein from above. The sample adapter 18 has an identification portion (not shown). Information such as a type (process information) of the sample, a type (size) of the sample container 11 and the like are set, then the identification of the sample is read at the start of the measurement by an identification sensor 30 (see FIG. 2), which is disposed on the outer circumference of the sample tray 2, in order to determine whether the sample is to be diluted, whether the blood plasma is to be filtered or the like, Subsequently, the liquid level variations associated with the size of the sample container 11 are calculated, and control depending thereon is performed. When filtering blood plasma is necessary, the relevant sample container 11 is fitted in a sample adaptor 18, and a holder with a filter (not shown) is mounted on the sample container 11 via a spacer (not shown).

The spotting unit 6 (see FIG. 1) has the movable frame 142 which is supported on a horizontal guide rail 41 of a stationary frame 40 so as to be horizontally movable. Two spotting nozzles 45 are mounted on the movable frame 42 so as to be vertically movable. A vertical guide rail 43 is fixed in the center of the movable frame 42, and two nozzle-fixing blocks 44 are arranged at opposed sides of the vertical guide rail 43. Upper ends of the spotting nozzles 45 are respectively fastened to the lower part of the nozzle fixing blocks 44. Each of the nozzle-fixing blocks 44 has a shaft-like member which extends upward and passing through a drive transmission member 47. A compression spring interposed between the nozzle fixing block 44 and the drive transmission member 47 provides the nozzle tip 14 with an engaging force.

The nozzle fixing block 44 is vertically movable together with the drive transmission member 47 as one, and when the nozzle tip 14 is fitted to the end of the spotting nozzle 45, the compression spring is compressed, which allows the drive transmission member 47 to move downward with respect to the nozzle fixing block 44.

The drive transmission member 47 is fixed to a belt 50 which is tensed between upper and lower pulleys 49, and vertically moved in association with the movement of the belt 50 driven by a motor not shown. A balance weight 51 is mounted on the outside of the belt 50 for preventing the spotting nozzle 45 from moving downward except during driving.

The horizontal travel and independent vertical movements of the spotting nozzles 45 are controlled by the facts that the movable frame 42 is horizontally traveled by a belt driving mechanism (not shown) and the two nozzle fixing blocks 44 are vertically moved independently of one another. In this way, the two spotting nozzles 45 are allowed to horizontally travel as one and vertically move independently of one another. For example, one of the spotting nozzles 45 is for the sample, and the other is for the diluent or the reference solution.

Each of the spotting nozzles 45 is formed in the shape of a rod including an air passage extending therethrough in the axial direction, and a pipette-like nozzle tip 14 is sealingly fitted to the lower end portion of the nozzle. These spotting nozzles 45 are respectively coupled to air tubes connected to syringe pumps (not shown) or the like, and a suction force and a discharge force are selectively supplied to each of the spotting nozzles 45. Further, the liquid surface of the sample or the like can be detected based on variation of the suction pressure.

The tip disposal area 9 comprises an upper member 81 and a lower member 82, and is positioned so as to vertically intersect with the transfer path R. A drop hole 83 having an oblong shape is provided in this tip disposal area 9 of a supporting table 61. The upper member 81 is fastened to the upper surface of the supporting table 61 and provided with an engagement cutout 84 just above the drop hole 83. Meanwhile, the lower member 82 is provided on the lower surface of the supporting table 61 so as to surround the lower part of the drop hole 83 and serves to guide a dropping nozzle tip 14.

The spotting nozzle 45 with which the nozzle tip 14 is fitted is first moved downward into the upper member 81, and then horizontally moved such that the engagement cutout 84 of the upper member 91 is engaged with the upper end of the nozzle tip 14. The spotting nozzle 45 is then moved upward, whereby the nozzle tip 14 is removed therefrom. The removed nozzle tip 14 is dropped through the drop hole 83 for disposal.

The first incubator 4 for making a colorimetry measurement comprises a toroidal-shaped rotary member 87 at a radially outward region thereof. The rotary member 87 has an inclined rotary pipe 88 fixed on the radially inward side of the lower surface of the rotary member. The lower part of the inclined rotary cylinder 88 is rotatably supported by a bearing 89 disposed below thereof, which allows the rotary member 87 to freely rotate. An upper member 90 is provided at the upper part of the rotary member 87 so that the upper member 90 can rotate integrally with the rotary member 87. The bottom surface of the upper member 90 is flat, and the upper surface of the rotary member 87 has a plurality of recesses (in the case of FIG. 1, thirteen recesses) spaced at predetermined intervals. Element chambers 91 in the form of a alit are formed between the members 87 and 90. Each element chamber 91 is provided so that the bottom surface thereof is positioned at the same level as that of the conveying surface. The hole of the inclined rotary cylinder 88 surrounds a discarding hole 92 for discarding the dry analysis elements 12 after measurement, The used dry analysis measurement 12 in the element chamber 91 is moved towards the center of the rotary member as it is, and dropped through the discarding hole 92 for disposal.

The upper member 90 comprises a heater (not shown) for incubating the dry analysis elements 12 within the element chamber 91 at a predetermined temperature (for example, 37±0.2° C.) by the temperature control thereby. The upper member 90 further comprises a pressing member (not shown) which faces the element chamber 91 and presses the mount of the dry analysis element 12 from above to prevent evaporation of the sample. A heat insulating cover 94 is provided on the upper surface of the upper member 90, and the entire first incubator 4 is covered with a light shielding cover 95. Further, a photometric opening 91a is formed in the center of the bottom surface of each element chamber 91 of the rotary member 87. The reflection density of the dry analysis element 12 is measured through the photometric opening 91a by a photometer head 96 disposed at 3 the position shown in FIG. 1. The first incubator 4 is rotated in both directions by a belt mechanism (not shown).

The element discarding mechanism 10 comprises a discarding bar 101 which can advance into or withdraw from the element chamber 91 in a radial direction. The discarding bar 101 is fastened at the rear end to a horizontally running belt 102, and pushes out the measured dry analysis element 12 for disposal from the element chamber 91 depending on the movement of the belt 102 driven by a driving motor 103. A collection box for collecting the dry analysis elements 12 after measurement is provided under the discarding hole 92.

The blood plasma filtering unit (not shown) is inserted into the sample container (e.g., a blood-collecting tube) 11 held in the sample tray 2 and suctions plasma through a holder (not shown) with a glass fiber filter which is mounted on the upper end of the sample container, thereby separating plasma from the blood and holding the separated plasma in a cup formed at the top of the holder.

In the following, the spotting station 3, the transport mechanism 8, and the second incubator 5 will be described with reference to FIG. 3 to FIG. B.

The spotting station 3 and the transport mechanism 8 have a long supporting table 61 which extends between the sample tray 2 and the first incubator 4 in the direction perpendicular to the element transfer path R, and a sliding frame 62 is provided on the supporting table 61. A planar cover 70 as shown in FIG. 3 is provided on the sliding frame 62. This cover 70 includes an opening 70a at a position corresponding to the spotting station 3.

An element retainer 64 which is used when spotting a colorimetric dry analysis element 12, and an upper block 63 of the second incubator 5 which is used when spotting an electrolytic dry analysis element 12 are placed adjacent one another on the sliding frame 62. The upper block 63 and element retainer 64, both of which are movable together with the sliding frame 62 as one, include spotting openings 63a and 64a, respectively, The sliding frame 62 is guided at one end by a guide groove 65, and comprises a long slit 62a engaged with a pin 66 and a rack gear 62b meshed with a driving gear 67 of a driving motor 68, both of which are disposed on the side of the other end.

FIG. 2 illustrates a state when transferring and spotting the electrolytic dry analysis element 12, while FIGS. 3 and 4 illustrate a state when transferring and spotting the colorimetric dry analysis element 12. More specifically, when transferring and spotting the colorimetric dry analysis element 12, the element retainer 64 is positioned at the spotting station 3, and when transferring and spotting the electrolytic dry analysis element 12, the sliding frame 62 is activated such that the upper block 63 of the second incubator 5 is positioned at the spotting station 3.

When a colorimetric dry analysis element 12 is transferred from the sample tray 2 as described above, the element retainer 64 is positioned at a spotting station 3 (see FIG. 4). The colorimetric dry analysis element 12, after being spotted with a sample in the element retainer 64, is pushed out by the element transfer mechanism and transported to the first incubator 4. On the other hand, when an electrolytic dry analysis element 12 is transferred from the sample tray 2, the sliding frame 62 is moved and the upper block 63 is positioned at the spotting station 3 (see FIG. 2). After the electrolytic dry analysis element 12 is spotted with a sample and reference solution, the sliding frame 62 is returned to its original position and the electrolytic dry analysis element is slidingly moved on the supporting table 61 with the element being retained by the upper block 63, transported to and incubated in the second incubator 5, and subjected to the potentiometry measurement. At this time, the element retainer 64 is positioned at the spotting station 3 as shown in FIG. 4, and therefore, it is allowed to spot the subsequently supplied calorimetric dry analysis element 12 with the sample and to feed the spotted element to the first incubator 4. After completion of the measurement in the second incubator 5, the sliding frame 62 is further moved such that the dry analysis element 12 after measurement is conveyed to and dropped into the discarding hole 69 for disposal.

In the second incubator 5, the upper block 63 of the aforementioned sliding frame 62 serves as an element retainer, and a single element chamber is defined between the upper block and the upper surface of a lower block 71. The lower block 71 is provided with a heater (not shown), and the dry analysis element 12 is incubated at a predetermined temperature (30±1° C.) by controlling the temperature of the heater. Three pairs of potential measuring probes 78 for measuring the ion activity are positioned adjacent to the side of the lower block 71 so that they can be brought into contact with the ion selective electrodes of the electrolytic dry analysis element 12.

As shown in FIGS. 6A-6C, the lower block 71 is disposed on an upper side of a body portion 72 so as to extend upward. The body portion 72 is supported in a manner to be movable up and down by guide rods 76 which are erected on a lower frame 77 of the apparatus. The lower block 71 incorporates therein a spring which allows the lower block to move in and out of the body portion 72. The three pairs of potential measuring probes 78 are erected on both sides of the lower block 71 (three on each side) on the upper surface of the body portion 72 and can move Up and down together with the lower block 71. Each of the potential measuring probes 78 incorporates therein a spring which allows the potential measuring probe to move in and out of the body portion.

A driving motor 73 is provided alongside the body portion 72, and a cam member 74 (see FIG. 4) is mounted on a rotary shaft of the driving motor 73. This cam member 74 is associated with an abutment member 75 secured to the sidewall of the body portion 72. As the driving motor 73 rotates, the cam member 74 vertically moves the body portion 72 via the abutment member 75 from an upper position of FIGS. 3 and 4 to a lower position of FIG. S. This allows the lower block 71 and the potential measuring probes 78 to be moved vertically towards and away from the upper block 63.

An opening 61a (see FIGS. 6A-6C) through which the upper end of the lower block 71 can pass is formed in the supporting table 61 at a position located above the lower block 71 and corresponding to the second incubator 5. The peripheral edges of the supplied electrolytic dry analysis element 12 are supported by an edge part surrounding the opening 61a. Further, through holes 61b, each of which the ! tip of the potential measuring probe 78 can pass through, are formed on both sides of the opening 61a, The supporting table 61 also has a discarding hole 69 disposed to the side of the second incubator 5.

When the body portion 72 is in the lower position, the lower block 71 and the upper ends of the potential measuring probes 78 are, as shown in FIG. 6B, positioned under the upper surface (transfer surface) of the supporting table 61 and are not in contact with the electrolytic dry analysis element 12. When raised, the upper end surface of the lower block 71 passes through the opening 61a of the supporting table 61 and abuts the lower surface of the upper block 63 or the lower surface of the dry analysis element 12. Then the tips of the potential measuring probes 78 pass through the through holes 61b beyond the ends thereof and abut the upper block 63. At this time, if the dry analysis element 12 is present, these tips are electrically connected with the ion selective electrode pairs of the dry analysis element 12.

In the second incubator 5, before the electrolytic dry analysis element 12 is accommodated therein, the lower block 71 is raised so that the upper end surface of the lower block 71 and the lower surface of the upper block 63 are brought in contact with each other as shown in FIG. 6A. As a result, heat of the lower block 71 under the temperature control of the heater is transferred to and preheats the upper block 63. A heat capacity of the lower block 71 and a heating value of the heater are selected in consideration of the heating requirement of the upper block 63.

Then, when an electrolytic dry analysis element 12 is carried from the sample tray 2 for spotting, the body portion 72 is lowered such that the lower block 71 and the potential measuring probes 78 are separated from the upper block 63 as shown in FIG. 6B. In this lowered state, the upper block 63 is moved to the spotting station 3 in association with the movement of the sliding frame 62, and the dry analysis element 12 is fitted between the lower part of the upper block 63 and the supporting table 61 and spotted with the sample and reference solution.

Subsequently, after the spotted electrolytic dry analysis element 12 is moved together with the upper block 63 to the second incubator 5 in association with the movement of the sliding frame 62, the lower block 71 is, as shown in WIG. SC, raised to sandwich the dry analysis element 12 between the lower block 71 and the upper block 63. The dry analysis element 12 is quickly heated by the heat of the upper block 63 and lower block 71 which are in contact with the upper and lower surfaces of the element, and subjected to ion activity measurement after being heated for a predetermined period of time. Note that heating of the dry analysis element 12 is started when the element contacts the upper block 63.

When measuring the electrolytic dry analysis element 12, the sample is spotted in one of its spotting holes while reference solution is spotted in the other of its spotting holes so that potential differences are generated between the ion selecting electrode pairs of the dry analysis element in accordance with the differences in Cl⁻, K⁺, and Na⁺ion activities between the reference solution and the sample. Then, the dry analysis element is sandwiched between the upper and lower blocks 63, 71 for incubation. During this incubation, the three raised pairs of potential measuring probes 78 are brought into contact with the ion selective electrode pairs of the dry analysis element 12 to detect the potential differences between the ion selective electrode pairs, and the activities of the respective ions in the sample (blood plasma) are determined on the basis of the detection result. The ion activities measured in this way are displayed on a display panel such as a liquid crystal panel, etc., or recorded on recording paper.

Note that the amount of the upward movement of the body portion 72 is constant independently of the presence of the dry analysis element 12, and the movement of the body portion 72 after the lower block 71 and the tips of the potential measuring probes 78 abut the element and stop is absorbed by the action of the incorporated springs.

The aforementioned cover 70 has a base portion 7a which covers at least the upper part of the second incubator 5 and is formed of a metal material, as shown in FIG. 7. On the other hand, a part of the cover 70 to be contacted with the upper block 63, that is, the lower part of the cover 70 to which the upper surface of the upper block 63 contacts as a result of the movement of the upper block 63 in association with the raising of the lower block 71, is formed of a heat insulator 7b such as resin. A recess 70b is formed in the heat insulator 7b in order to reduce the area of contact with the upper block 63.

The base portion 7a or the cover 70 is made of, for example, stainless steel, aluminum alloy or the like and serves to shield the second incubator 5 from outside influences, thereby improving the accuracy of measuring the quantity of weak electricity therein. Meanwhile, the heat insulator 7b prevents the heat of the upper block 63 from being dissipated into the cover 70, thereby increasing the preheat efficiency by the lower block 71.

The heat insulator 7b of the cover 70 may be provided over the entirety of the lower surface of the cover 70 as shown in FIG. 7, or embedded in the cover at a part that contacts the upper surface of the upper block 63 as shown in FIG. 8. In the latter case, it is also preferable to form a recess 70b in the heat insulator 7b.

The preheating time period for preheating the upper block 63 by contact with the lower block 71 as mentioned above can be controlled to change according to the environmental temperature. In other words, the time required for preheating the upper block 63 increases when the environmental temperature is low. By way of example, the preheating time may be set to 20 seconds at an environmental temperature of 25° C., and set to 100 seconds at 15° C.

If, for example, the electrolytic dry analysis elements 12 are supplied continuously, the subsequent dry analysis element 12 is controlled such that it is made to wait without being subjected to the spotting operation until the measurement of the preceding dry analysis element 12 is completed and a predetermined preheating time is elapsed after the lower block 71 is brought into contact with the upper block 63, and then, the subsequent dry analysis element 12 is fed for spotting after the preheating time has elapsed. This avoids deterioration in measuring accuracy due to the fact that an electrolytic dry analysis element 12 is spotted before sufficient preheating is performed, in which situation the incubation as a measurement condition is inadequate.

The overall operation of the aforementioned biochemical analysis apparatus 1 will be described hereinbelow. Before making an analysis, sample containers 11 respectively containing samples, an element cartridge 13 holding therein dry analysis elements 12, a tip rack 19 containing nozzle tips 14, a mixing cup 16, a diluent container 15, and reference solution container 17 are mounted to respective mounting sections 23 to 28 in the sample tray 2, and a measurement setup is performed.

Then, the analysis processing is started. When blood plasma of the sample is to be filtered, the blood plasma is first separated from the whole blood in the sample container 11 by the blood filtering unit. Thereafter, to stop the element cartridge 13 of the sample to be measured at the corresponding element-takeout position, the rotary disk 21 is rotated, and the dry analysis element 12 is removed from the element cartridge 13 and fed to the spotting station 3 by means of the element transfer mechanism. Before being fed to the spotting station 3, analysis-information affixed to the dry analysis element 12 is read and the subsequent operations are controlled based thereon.

When the measuring item specifies colorimetry, the dry analysis element 12 is transferred with the element retainer 64 being positioned at the spotting station, and subsequently the sample tray 2 is rotated to bring a nozzle tip 14 of the tip rack 19 below the spotting nozzle 45. Then the sample container 11 is moved and the spotting nozzle 45 is moved downward to dip the nozzle tip 14 into the sample and to cause the nozzle tip 14 to suction the sample. Thereafter the spotting nozzle 45 is moved to the spotting station 3 and spots the sample onto the dry analysis element 12 at the spotting station 3.

Then the colorimetric dry analysis element 12, which is spotted with the sample, is inserted into the first incubator 4. Subsequently, the element chamber 91 is rotated and the dry analysis element is incubated for a predetermined period of time. The dry analysis element 12 disposed within the element chamber is then moved to the position of a photometer head 96 for measuring the reflective optical density of the dry analysis element 12. After this measurement, the measured dry analysis element 12 is pushed out towards the central portion for disposal. The result of the measurement is output and the used nozzle tip 14 is removed from the spotting nozzle 45 at the tip disposal area 9 and dropped for disposal. Then, the process is completed. During this colorimetry measurement, in the second incubator 5, the lower block 71 is raised to preheat the upper block 63 as described above.

When the sample is to be diluted, e.g., when the density of blood plasma is too high to make accurate inspection, the dry analysis element 12 is carried to the spotting position, then the nozzle tip 14 is attached to the spotting nozzle 45, and the spotting nozzle 45 is lowered to suction the sample into the nozzle tip 14. After dispensing the suctioned sample from the nozzle tip 14 to the mixing cup 16, the used nozzle tip 14 is removed from the spotting nozzle. Then, a new nozzle tip 14 is attached to the spotting nozzle 45 in order to suction the diluent from the diluent container 15, and the suctioned diluent is discharged from the nozzle tip 14 to the mixing cup 16. Thereafter, the spotting nozzle dips the nozzle tip 14 into the mixing cup 16 and causes the nozzle tip 14 to repeat suction and discharge, thereby stirring the mixture in the mixing cup 16. After stirring, the diluted sample is auctioned by the nozzle tip 14, and the spotting nozzle 45 with the diluted sample is moved to the spotting section 3 to spot the dry analysts element 12 with the diluted sample. Incubation, photometry, discarding of elements output of results, discarding of nozzle tips are performed on the dry analysis element in the same manner as mentioned above, and the process is completed.

In the case of ion activity measurement, after the upper block 63 is moved to the spotting section 3 and an electrolytic dry analysis element 12 is supplied to the spotting station as described above, a nozzle tip 14 is first attached to one of the spotting nozzles 45 to suction the sample. Then another nozzle tip 14 is attached to the other of the spotting nozzles 45 to suction the reference solution from the reference solution container 17. Thereafter, the sample is spotted in one of the spotting holes of the dry analysis element 12 by means of one of the spotting nozzles 45, and the reference liquid is spotted in the other spotting hole of the dry analysis element 12 by means of the other spotting nozzle 45.

The dry analysis element 12, which is spotted with the sample and reference solution, is transported together with the upper block 63 from the spotting station 3 to the second incubator 5 as a result of the movement of the sliding frame 62, where the lower block 71 is raised to incubate the dry analysis element. In this state, the ion activity is measured by the potential measuring probes 78. After completion of the measurement, the used dry analysis element 12 is carried to and dumped into the discarding hole 69 by means of the movement of the sliding frame 62. Then, the result of the measurement is output and the used nozzle tips 14 are removed from the both spotting nozzles 45 for disposal, and the process is completed.

Accordance to the foregoing embodiment, in the second incubator 5 for measuring the ion activity, the upper block 63 not having a heater is preheated by contact with the lower block 71 having a heater before a dry analysis element 12 is interposed between the upper block 63 and the lower block 71, thereby efficiently heating the dry analysis element 12 by both blocks 63, 71 contacting both aides of the element. As a result, a predetermined temperature can be reached in a short time even if a cold dry analysis element 12 is set in place for the potentiometry measurement using the potential measuring probes 78, which improves the accuracy of the measurement. Further, since only the lower block 71 is provided with the heater, the incubator is simplified in terms of structure.

The above embodiment has been described through the example that the heater is provided in the lower block 71. However, the heater may be provided in the upper block 63 for preheating the lower block 71. However, it is also possible that the upper block 63 is provided to be movable vertically together with a dry analysis element 12 towards and away from the lower block 71. When the upper block 63 is provided to move vertically, the upper block 63 may have potential measuring probes 78.

Further, the above embodiment has been described through the example that lower block 71 is moved up and down when inserting and removing the dry analysis element 12. However, it is also possible to provide a structure in which one of the upper block 63 and lower block 71 is always urged by urging means so as to be in contact with the other, and a dry analysis element 12 is inserted therebetween against the urging force.

Although, in the above embodiment, both of the upper block 63 and lower block 71 are allowed to move towards and away from the dry analysis element 12, the present invention is not limited thereto. This invention can be applied to a case in which at least one of the blocks is made movable towards and away from the dry analysis element 12.

Further, in the above embodiment, the upper block 63 and the lower block 71 sandwich the dry analysis element 12 from above and below. However, the present invention is not limited to this construction, and it is possible to sandwich the dry analysis element 12 in the horizontal direction or the like.

Still further, in the above embodiment, the heater is provided only in the lower block 71. However, heaters may be provided in both the upper block 63 and the lower block 71. In this case, the heaters may be controlled so as to switch between using one or both heaters, according to the environmental temperature (for example, turning one of the heaters OFF when the environmental temperature is high, and turning both of the heaters ON when the environmental temperature is low). It is also possible to employ one of the heaters as the main heater, while the other heater may be employed as an auxiliary heater, having smaller heating capacity and electric current values, etc.

What is claimed is:

1. An incubator for accommodating and holding at a predetermined constant temperature a dry analysis element spotted with a sample, comprising:
first and second blocks, at least one of which is movable towards and away from the other, for sandwiching therebetween the dry analysis element; and
a heater provided in at least one of the blocks,
wherein the first and the second blocks are brought into contact with each other for preheating the blocks before introducing the dry analysis element therebetween.

2. An incubator according to claim 11 wherein the heater is provided in the first block, which is a lower block, for temperature-controlling the lower block; the lower block and the second block, which is an upper block, are brought into contact with each other: the upper block is preheated by heat transmission; a dry analysis element is introduced and sandwiched between the lower block and the upper block; and the dry analysis element is heated by the heat of both blocks.

3. An incubator according to claim 1, wherein the dry analysis element is an electrolytic dry analysis element used for measuring the ion activity in a sample, and potential measuring probes are provided at the one block which is movable towards and away from the other of the first and second blocks.

4. An incubator according to claim 2, wherein the dry analysis element is an electrolytic dry analysis element used for measuring the ion activity in a sample, and potential measuring probes are provided at the one block which is movable towards and away from the other of the upper and lower blocks.

5. An incubator according to claim 1, further comprising a cover made of a metal material which covers the second block, wherein the cover has a heat insulator placed at a part that contacts the second block.

6. An incubator according to claim 2, further comprising a cover made of a metal material which covers the upper block, wherein the cover has a heat insulator placed at a part that contacts the upper block.

7. An incubator according to claim 3, further comprising a cover made of a metal material which covers the second block, wherein the cover has a heat insulator placed at a part that contacts the second block.

8. An incubator according to claim 4, further comprising a cover made of a metal material which covers the upper block, wherein the cover has a heat insulator placed at a part that contacts the upper block.

9. An incubator according to claim 5, wherein the heat insulator of the cover is provided with a recess.

10. An incubator according to claim 6, wherein the heat insulator of the cover is provided with a recess.

11. An incubator according to claim 7, wherein the heat insulator of the cover is provided with a recess.

12. An incubator according to claim of wherein the heat insulator of the cover is provided with a recess.

13. An incubator according to claim 1, wherein the preheating time is changed according to the environmental temperature.
